(19) United States
(12) Patent Application Publication
(10) Pub. No.: US 2010/0070097 A1
(43) Pub. Date: Mar. 18, 2010

(54) REMOTELY CONTROLLED FIRE PROTECTION SYSTEM

(76) Inventors: Paul Morgenstern, Austin, TX (US); Robbie Clark, Austin, TX (US); James Jolly Clark, Austin, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/562,871

(22) Filed: Sep. 18, 2009

Related U.S. Application Data
(60) Provisional application No. 61/098,230, filed on Sep. 18, 2008.

(51) Int. Cl. G05D 7/06

(52) U.S. Cl. 700/284; 700/283

(57) ABSTRACT

Method and apparatus for remotely controlling a fire protection system for buildings. This method of fire protection uses a wireless or wired control system to remotely activate a fire protection system by sending it an activation signal or activation message wherein one or more commands can configure the system with specified operation instructions. The system utilizes roof top sprinklers and may additionally utilize existing irrigation systems or additional zones only used during the prevention of wildfires to wet down area in advance of fires. The system can be controlled by various municipal fire authorities that are given the authority to control fires. Immediate control of the system is always available to the transmitting authority. When activated, the central processor communicates to the authority that activated the fire protection system. The central processor transmits information back to the transmitting authority such as but not limited to water flow confirmation, water pressure, air temperature, roof temperature, wind direction, humidity and still or live images of the protected property.

### PRIORITY CLAIM

This application claims the benefit of priority of U.S. Provisional Patent Application Ser. No. 61/098,230 entitled “REMOTELY CONTROLLED FIRE PROTECTION SYSTEM”, filed on Sep. 18, 2008, whose inventors are Paul Morgenstern, Robbie Clark and James Jolly Clark, which is hereby incorporated by reference in its entirety as though fully and completely set forth herein.

### BACKGROUND OF THE INVENTION

1. Field of the Invention

The invention generally relates to a method and apparatus for remotely controlling fire protection systems.

2. Description of the Relevant Art

There are minimal ways to protect buildings and or property from wildfires. The only methods available up to this time have been the fire department or the use of fire retardants around the property. The fire department must be on site to protect the building. In addition there may be many buildings threatened in a wildfire situation. Fire retardants have to be repeatedly applied to the property each fire season and have reduced effectiveness after rains wash them away or heavy winds blow them away. Additionally, there is a negative environmental impact from surrounding homes and businesses with the chemicals found in fire retardants. There is currently no method available for a fire authority to remotely mitigate potential exterior structure fires resulting from wide spread wild fires, proximal structure fires or proximal brush fires. There is no currently viable method available for fire authorities to determine if any existing fire protection system have been activated. There are no current viable systems that give the fire control authority a method to remotely turn off a fire suppression system that was activated autonomously or remotely. Water pressure is a concern in large fire areas since fire fighters may require a specific amount of water pressure to effectively fight a conflagration. There are no current viable systems that can detect water pressure so as to active and deactivate fire protection systems or adjust which zones are active within the systems in order to maintain a desired water pressure within the area. There are no current systems that collect onsite information such as water flow, water pressure, wind speed, wind direction, temperature etc. and sends the information back to the fire authority to alert them of current conditions. There are no current system that create a network for collecting environmental data from individual fire suppression systems and then sharing that data over a wired or wireless network with fire suppression systems in the same geographic region so the other systems can utilize this environmental and fire risk data to autonomously to location and distance of local fire hazards. There are no existing systems that act as a peer-to-peer mesh network to continue to autonomously communicate directly with other proximal fire suppression systems to share current environmental and fire threat data without the communication first being routed through a central control authority when communication to the central control authority is cut off. There are no existing solutions that are alerted when communication to a remotely controlled fire protection system has failed. There are no existing solutions that have the ability to adjust the roof or property wetting strategy based on current environmental and fire conditions such as wind speeds, wind direction and/or temperature by changing the wetting methodology or adjusting which sprinklers are active and the duration they are active in order to maximize the water concentration in the most effective location by minimizing the amount of water blown away due to high wind common during wild fires. There are no current solutions that can automatically or manually adjust the roof or property wetting strategy to concentrate water in areas of higher combustion risk or areas determined by sensors to have higher temperature concentrations relative to surrounding areas, potentially caused by a burning ember.

Adaptive, self learning, embedded micro controllers are shown and disclosed in U.S. Pat. Nos. 6,314,340 and 6,298,285, which are incorporated herein by reference. That or similar technologies may be used in the method and apparatus disclosed herein. U.S. Pat. No. 6,360,968 B1 taught roof mounted rotating sprinkler heads could be used for wildfire protection. The method is insufficient in that a remote method of activation is not described. U.S. Pat. No. 5,931,233 taught a fire suppression system could be remotely activated by sound. This method does not relay information back to the fire authority, in addition the fire authority may need to remotely activate and deactivate the system to maintain water pressure in a given area. U.S. Pat. No. 6,450,264 B1 has also taught roof mounted sprinkler heads could be used for wildfire protection. The method is insufficient in that a remote method of activation is not described.

U.S. Pat. No. 6,952,169 B1 taught a fire suppression system could be remotely activated by a wireless signal. This method does not relay information back to the fire authority, in addition the fire authority may need to remotely activate and deactivate the system to maintain water pressure in a given area.

U.S. Pat. No. 5,125,458 taught a fire suppression system could be remotely activated by a portable signal transmitter or telephone. Further Berman teaches remote smoke detectors or heat sensors could be used to activate the fire suppression system. Berman also teaches a battery could be used to power the system in the event power from the main lines were unavailable. This method does not relay information back to the fire authority, in addition the fire authority may need to remotely activate and deactivate the system to maintain water pressure in a given area.

U.S. Pat. No. 6,340,058 taught of a heat triggered fire suppressant devices. This method is insufficient since it releases the fire suppressant only when the container is exposed to extreme heat rather than being remotely activated to release the fire suppressant into the water lines.

U.S. Pat. No. 6,629,569 teaches of a roof mounted pop-up sprinkler system that dispenses fire retardant. This method is insufficient as it does not contain a remote triggering activation feature and it only focuses on built-in sprinkler systems rather than exterior mounted sprinklers. The method for dispersing the fire suppressant is dissimilar as the fire suppressant used in this solution will be introduced into the watering lines with a siphon.

### SUMMARY OF THE INVENTION

This method and apparatus permits large-scale manipulation of individual residential and commercial fire protection systems by a single fire authority. A central authority can be used to send out commands to the fire control systems or a local control may be provided with handheld transmitters which the various fire authorities have as equipment.

In addition the method permits the fire authority to determine if the fire protection has been activated and is working according to specifications. When activated, the central processor communicates back to the authority that activated the fire protection system. The central processor transmits back information such as but not limited to water flow, water pressure, wind speed, wind direction, air temperature, roof temperature, and still, live, thermal or infrared images of the protected property. The fire authority may use the data fed back from the apparatus, satellite mapping software, field reports, or direction visual confirmation from the fire areas to determine the appropriate time to activate the fire prevention apparatus. The fire authority may use this information to remotely activate individual homes or commercial buildings or multiple blocks of residential and commercial buildings that have the fire control system installed.

The fire protection system includes a central processing unit, remote sensors, and connections to one or more communication devices/systems. The central processor controls a plurality of valves placed on the roof and other places on the property surrounding the building. The central processor may be activated by a plurality of methods. The central fire authority may activate the system with handheld transmitters using UHF or VHF frequencies. The central processor may be activated by UHF or VHF such as pager or telephone systems that currently or will exist in the community. The central processor may be connected to WiFi networks, Ethernet, broadband wide area wireless networks, phone lines, cell phone, cable modem based communication. Any of these communication methods can be used to activate the central processor. The central processor may be activated by mobile-based transmitters utilizing UHF, VHF, cellular phone or satellite based communication. The central processor may be activated by web-based applications or portable web based hand held devices. The central processor may be activated by wireless or wired sensors that include but are not limited to perimeter fire, smoke or heat alarms. The central processor may be activated by roof top mounted fire, smoke or heat sensors. The central processor may be activated by a peer-to-peer mesh network where a fire suppression system alerts other nearby fire suppression systems that a fire threat is near. The central processor is able to remain active for extended periods of time via a battery backup system with alternative solar cell or by a power generator

The fire protection system may be connected to and activated by home security or fire alarms.

The fire protection system may activate the home security-fire alarm.

The fire protection system may be activated by remote sensors on the property.

When fire protection system is activated, the central processor may go into wildfire mode. Wildfire mode cycles through the various water nozzles and/or water hoses and wets down the fire prone areas of the property. In areas where UHF or VHF communications are poor and the wired communication systems are inoperable, the fire protection will be able to protect the property autonomously.

The central processor may be activated by wired or solar powered, battery backup remote sensors that include but are not limited to air temperature, roof temperature, wind speed, wind direction, humidity, still, live, infrared or thermal images of the protected property. There can be a plurality of remote sensors that communicate with the central control unit. Each sensor may send location and a plurality of environmental information back to the central control unit. The information can then optionally be forwarded to the fire control authority. The fire control authority collects all the environmental data from individual system, assess the fire risk to each property protected by a fire suppression system and broadcast all known fire risk data back to systems deemed to be threatened by a proximal fire threat. Each individual system uses the new data sent from the fire control authority to adjust its level of fire protection based on nearby fire threats and can in turn automatically activate its own fire suppression system based on its proximity and assessed weather conditions to a known fire threat.

When activated the central processor turns on in sequence various valves and nozzles wetting down the roof and surrounding areas of the property. The valves and nozzles may be wired or wireless devices. The system may utilize existing irrigation systems. By activating the sections of the existing irrigation the effectiveness of the fire protection system will be increased as well as keeping landscaping watered during periods of evacuation when power is not typically available and standard irrigation systems will not operate. The system may also utilize water nozzles and/or watering devices not used during standard landscape irrigation that are strategically placed to wet down sources of fire fuel near the structure such as trees, bushes and scrub brush to prevent these sources of fire fuel from igniting.

When activated the central processor communicates back to the fire authority that the fire protection system has been successfully activated. The central processor transmits back information such as but not limited to water flow, water pressure, air temperature, roof temperature, wind speed, wind direction, humidity, still, live, infrared or thermal images of the protected property. This valuable information can assist the fire authority in creating a more comprehensive and accurate fire fighting strategy.

When activated, based on inputs from sensors such as but not limited to water pressure, air temperature, roof temperature, wind speed, wind direction and direction of approaching fire, the central processor can adjust the water soaking strategy to maximize the amount of water hitting its target and minimizing unnecessary water wasted.

When activated the central processor sounds an alarm beep or message so personnel are aware the fire control system will soon activate allowing them time to move away from the system so as not to get wet.

The central processor will periodically run diagnostic tests on the system as well as each component contained in or controlled by the system and report the results of the tests back to the fire control authority and/or a centralized monitoring tool where the results of the diagnostic tests are used to determine if any actions are necessary to repair or improve the system.

The central processor will periodically update the fire control authority and/or a centralized monitoring tool to any physical changes made to the system such as the addition or removal of irrigation zones.

The central processor can initiate communication back to the fire control authority and/or a centralized monitoring tool for a plurality of reasons including but no limited to report current instrument readings, send alerts based on changes in sensors, send diagnostic results or to provide a system status update.

Communications initiated by the central processor to the fire control authority and/or centralized monitoring tool can be both scheduled and activity based.

Communications to the central processor from the fire control authority and/or centralized monitoring tool may be initiated for a plurality of reasons including but not limited to activate or deactivate the central processor's fire protection system, sending the preventative watering schedule to be followed by the central processor, escalating or deescalating the current protective watering schedule, making modifications to the watering algorithms based on current weather conditions and/or wildfire activity.

Communications to the central processor from the fire control authority and/or centralized monitoring tool can be initiated based on a set schedule or communication can be initiated based on defined activities.

Fire authority refers to any entity that has an interest in protecting the property which includes but is not limited to: a fire department or government agency, private fire monitoring service, insurance company, property owner or manager, neighborhood association or individual or group who has access to manage the fire protection system through a monitoring tool such as a website capable of controlling the fire protection systems.

### BRIEF DESCRIPTION OF THE DRAWINGS

Advantages of the present invention will become apparent to those skilled in the art with the benefit of the following detailed description of embodiments and upon reference to the accompanying drawings in which:

FIG. 1 is a perspective view of a building and surrounding area with a fire protection system according to the present invention.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular faun disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

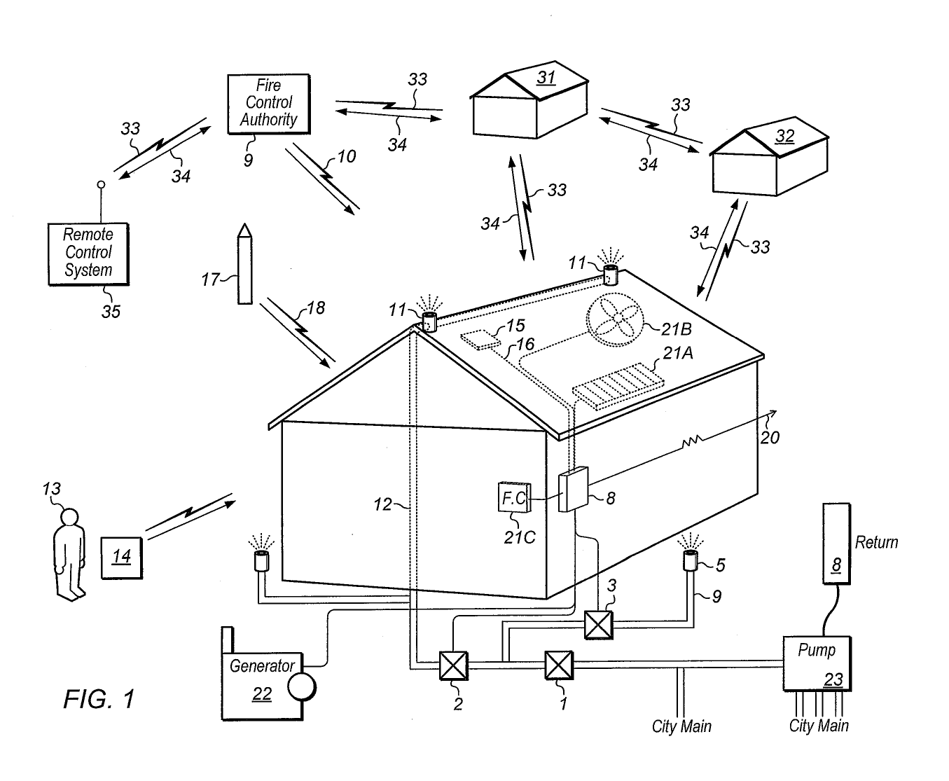

With reference now to FIG. 1, a new fire protection system for buildings using remote control embodying the principals and concepts of the present invention and generally designated by the reference numeral 8 will be described.

As best illustrated in FIG. 1, fire control system 8 generally includes a building with at least one water or misting nozzle 11 mounted on the house or in the ground spraying the side and roof of the structure, supplied with water via piping 12 controlled by manual valve 1 further controlled by water valve 2. In one embodiment Water valve 2 is controlled via wireless connection to the fire control system 8. In another embodiment water valve 2 is connected to the fire control system 8 with a wire or cable 6. Water valve 3 controlled by fire control system 8 allows water to flow via piping 4 to sprinkler nozzle 5. In one embodiment fire control system 8 is activated by heat sensor 15 via a wire or cable 16.

In one embodiment perimeter sensor 17 sends data via wireless connection 18 to fire control system 8. In another embodiment fire control authority 9 may activate fire control system 8 via a UHF of VHF signal. In another embodiment fire control authority 9 may activate fire control system 8 via a signal initiated by a web-based application. In another embodiment fire control authority 9 may activate fire control system 8 via Ethernet or Wifi network signal. In another embodiment fire control authority 9 may activate fire control system 8 via a cellular or wired phone line. In another embodiment fire control authority person or persons 13 may activate or configure the fire control system 8 via a wireless handheld device 14. In another embodiment fire control authority 9 may activate fire control system 8 via a satellite communication device 20.

Fire control system 8 may be powered by backup battery 19. Fire control system 8 may be powered by a plurality of alternative power supplies such as a solar panel 21A, a wind generator 21B or fuel cell 21C.

Fire control system 8 may be powered by a generator 22.

Additional water pumps 23 may be used to increase water pressure from city water line or provide water from an alternative water source such as a pool 24, rain barrel 26, cistern 27, body of water 28 or a well 29.

To improve the effectiveness of the fire control system, the incorporation of a fire retarding agent 30 may be incorporated into the water lines. The timing of the dispersal of this fire retarding agent is controlled by the fire control system 8. In another embodiment the timing of the dispersal of the fire retarding agent is controlled by the fire control authority 9.

A plurality remotely controlled fire protection systems in close proximity to each other 8, 31 and 32 can communicate directly with each other over a peer-to-peer mesh wireless UHF of VHF 33 or wired 34 network allowing them to share environmental and fire hazard data from their plurality of sensors. A remote system control 35 may be deployed to act as a communication link between the peer-to-peer mesh network and the central fire authority communicating over a plurality of wired or wireless communication methods.

In an embodiment, a method of remote and individual control of a plurality of individual residential and commercial fire protection systems, includes: sending a control signal from a transmitting authority to an individual residential and/or commercial fire protection system to activate the fire protection system; and sending information regarding the status of the fire protection system to the transmitting authority. The control signal may be sent using UHF or VHF frequencies of one way or two way pager facilities of a local pager company. The control signal may be sent using phone lines, cellular phone facilities or digital communication over a wireless digital network. The control signal may be sent using Wifi, Ethernet networks, or broadband wide area wireless networks. The control signal may be sent by satellite communication systems.

In some embodiments, the fire protection system may include a remote wired or wireless: heat sensor, temperature sensor, humidity sensor, air pressure sensor, infrared sensor, ultraviolet sensors or one or more of a combination of these sensors.

The fire protection system may be configured to receive control signals from web based applications or portable web based hand held devices or from a mesh network. In some embodiment, the fire protection system may be configured to receive control signals from a hand held wireless control device.

The fire protection system may include backup power provided by one or more of the following: a) battery backup system; b) fuel cell; c) solar power; d) hydroelectric; e) wind generator; or a f) power generator—i) wherein the power generator is initially powered on by a signal from the control unit or ii) wherein the power generator is manually started.

The fire protection system may also include a fire suppressant or fire retardant that can be introduced into the water lines to enhance the effectiveness of the fire protection system.

The central fire authority deploys a remote system control unit, capable of communicating with the peer-to-peer mesh network.

The fire protection system may be activated when one or more sensors determine that the system should be activated to protect the structure. In an embodiment, the fire protection system may be activated remotely by a fire authority. In an embodiment, the fire protection system may be activated remotely by the home owner or property manager. In an embodiment, the fire protection system may be activated remotely by the by the structures security system. In an embodiment, the fire protection system may be activated by a central monitoring tool.

In another embodiment, a method of controlling or preventing residential or commercial fires includes activating and individually controlling a plurality of water valves, water hoses and associated water nozzles using if available: a) existing irrigation system water valves and water nozzles; b) watering devices installed in fire fuel areas like trees, bushes and brush near the structure; c) watering devices installed to protect specific structures on or near the home such as decks, fences, sheds, roofs, exterior walls, vents, skylights, roof-mounted components such as solar panels and solar water heaters, roof features such as eves and overhangs, doors or areas determined to be at high risk of collecting wind blown embers.

In another embodiment, a method of controlling or preventing residential or commercial fires includes remote activation/de-activation and individual control of a plurality of water valves and associated water nozzles and watering devices to maintain water pressure in an active fire area.

In another embodiment, a method of controlling or preventing residential or commercial fires includes selecting the appropriate water valves and associated water nozzles to activate in order to maximize the amount of water hitting its target area as the result of environmental factors such as but not limited to wind speed, wind direction, fire direction and temperature.

A fire protection system may include two-way communication equipment configured to communicate with a central fire authority or centralized monitoring tool, wherein information is transmitted back and forth between the fire protection system and a central fire authority or centralized monitoring tool.

The fire protection system may include two-way communication equipment configured to use UHF or VHF frequencies of one way or two way pager facilities of a local pager company. In an embodiment, the two-way communication equipment is configured to use phone lines, cellular phone facilities or digital communication over a wireless digital network. In an embodiment, the two-way communication equipment is configured to use Wifi, Ethernet networks, broadband wide area wireless networks. In an embodiment, the two-way communication equipment is configured to use satellite communication. In an embodiment, the two-way communication equipment is configured to use a home alarm system wherein information is transmitted back and forth between the fire protection system and the home alarm system's monitoring service.

The fire protection system may also include remote wired or wireless: heat sensor, temperature sensor, humidity sensor, air pressure sensor, infrared sensor, ultraviolet sensors or one or more of a combination of these sensors. The fire protection system may also a web based applications or portable web based hand held devices.

The fire protection system may be programmed to automatically or based on sensor readings initiate communication with a central fire authority or centralized monitoring tool to perform at least one of the following functions: (a) exchange environmental and system readings from a plurality of onsite sensors; (b) receive control instructions; and (c) receive synchronization instructions.

The fire protection system may rely on environmental data sensor readings that include water flow confirmation, water pressure, water usage, air temperature, roof temperature, wind speed, wind direction, humidity and still, live, infrared or thermal images of the protected property.

The fire protection system may generate system readings that include system diagnostic information. The fire protection system may also include control instructions that contain station runtime settings, the station runtime settings including cycle time, duration, start and stop intervals and the sequence and timing of zone and valve operation. The fire protection system may include synchronization data, the synchronization data including a schedule that determines when each unit is allowed to operate so as to minimize the number of units active at the same time to preserve water pressure.

The central fire authority or centralized monitoring tool may automatically or based on inputs from the fire authority or centralized monitoring tool initiate communication to the fire protection system.

The fire protection system may include sensors that form a peer-to-peer mesh network with other sensors or fire protection systems. The remote system control unit can be remotely operated by the central fire authority.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method of remote and individual control of a plurality of individual residential and commercial fire protection systems, comprising:
sending a control signal from a transmitting authority to an individual residential and/or commercial fire protection system to activate the fire protection system; and
sending information regarding the status of the fire protection system to the transmitting authority.

2-16. (canceled)

17. A method of controlling or preventing residential or commercial fires comprising activating and individually controlling a plurality of water valves, water hoses and associated water nozzles using if available:
a) existing irrigation system water valves and water nozzles;
b) watering devices installed in fire fuel areas like trees, bushes and brush near the structure;
c) watering devices installed to protect specific structures on or near the home such as decks, fences, sheds, roofs, exterior walls, vents, skylights, roof-mounted components such as solar panels and solar water heaters, roof features such as eves and overhangs, doors or areas determined to be at high risk of collecting wind blown embers.

18-19. (canceled)

20. A fire protection system comprising two-way communication equipment configured to communicate with a central fire authority or centralized monitoring tool, wherein information is transmitted back and forth between the fire protection system and a central fire authority or centralized monitoring tool.

21. The fire protection system of claim 20, wherein the two-way communication equipment is configured to use UHF or VHF frequencies of one way or two way pager facilities of a local pager company.

22. The fire protection system of claim 20, wherein the two-way communication equipment is configured to use phone lines, cellular phone facilities or digital communication over a wireless digital network

23. The fire protection system of claim 20, wherein the two-way communication equipment is configured to use Wifi, Ethernet networks, broadband wide area wireless networks.

24. The fire protection system of claim 20, wherein the two-way communication equipment is configured to use satellite communication.

25. The fire protection system of claim 20, further comprising remote wired or wireless: heat sensor, temperature sensor, humidity sensor, air pressure sensor, infrared sensor, ultraviolet sensors or one or more of a combination of these sensors.

26. The fire protection system of claim 20, further comprising a web based applications or portable web based hand held devices.

27. The fire protection system of claim 20, wherein the two-way communication equipment is configured to use a home alarm system wherein information is transmitted back and forth between the fire protection system and the home alarm system's monitoring service.

28. The fire protection system of claim 20, wherein the fire protection system is programmed to automatically or based on sensor readings initiate communication with a central fire authority or centralized monitoring tool to perform at least one of the following functions:
(a) Exchange environmental and system readings from a plurality of onsite sensors;
(b) Receive control instructions; and
(c) Receive synchronization instructions

29. The fire protection system of claim 28, wherein the environmental data sensor readings include water flow confirmation, water pressure, water usage, air temperature, roof temperature, wind speed, wind direction, humidity and still, live, infrared or thermal images of the protected property.

30. The fire protection system of claim 28, wherein the system readings are system diagnostic information.

31. The fire protection system of claim 28, wherein the control instructions contain station runtime settings, the station runtime settings including cycle time, duration, start and stop intervals and the sequence and timing of zone and valve operation.

32. The fire protection system of claim 28, wherein the synchronization data includes a schedule that determines when each unit is allowed to operate so as to minimize the number of units active at the same time to preserve water pressure.

33. The fire protection system of claim 28, wherein the central fire authority or centralized monitoring tool automatically or based on inputs from the fire authority or centralized monitoring tool initiates communication to the fire protection system.

34. The fire protection system of claim 28, wherein the sensors form a peer-to-peer mesh network with other sensors or fire protection systems.

35. The fire protection system of claim 28, wherein the sensors form a peer-to-peer mesh network with a plurality of onsite sensors.

36. The fire protection system of claim 28, wherein the remote system control unit can be remotely operated by the central fire authority.
